(19) United States
(12) Patent Application Publication
(10) Pub. No.: US 2004/0058636 A1
(43) Pub. Date: Mar. 25, 2004

(54) Automatic cutting of products such as carcasses

(76) Inventors: Andrew William Hinsch, Carindale (AU); Philip Rodney Boyce, Murarrie (AU); Jeffrey Stewart Owen, Manly West (AU); Andrew Leslie Finney, Logan Central (AU)

Correspondence Address: MCDERMOTT WILL & EMERY, 600 13TH STREET, N.W., WASHINGTON, DC, 20005-3096, US

(21) Appl. No.: 10/398,896

(22) PCT Filed: Oct. 11, 2001
(86) PCT No.: PCT/AU01/01278

(30) Foreign Application Priority Data
Oct. 11, 2000 (AU) PR 0685

(51) Int. Cl. A22C 18/00

(52) U.S. Cl. 452/156

(57) ABSTRACT

Methods and apparatus are described for automatically splitting carcass (10) of a slaughtered animal. The apparatus includes saw assembly (17) mounted on carriage (22) and ultrasonic scanner (30). Assembly (17) is moved by carriage (22) along support (16) so that saw blade (18) commences cutting at the base of the spine and progressively advances downwardly following the line of the spine. Scanner (30) scans carcass (10) and the data signals are processed to locate the spine and/or determine its conformation immediately ahead of the point where blade (18) is splitting carcass (10). The processed signals are used to control the degrees of movement of blade (18) including lateral movement, rolling movement, vertical movement, tilting movement and yawing movement. The apparatus can also follow a desired line of cut in other medical, veterinary or forensic applications, or for cutting manufactured products, artefacts or achaeological articles having an internal structure.

This invention relates to cutting of products, such as biological products, and particularly (although not exclusively) to the splitting of animal carcasses, e.g. in abattoirs, boning plants, etc.

There are many fields in which cutting of products is desirably carefully controlled to account for variations in internal structures. For example, in cutting of human and animal tissues, including for medical and veterinary purposes, and for forensic purposes, the line of cutting or incision can be most important, e.g. to take account of the positions of organs, bones, muscles, tendons, nerves, arteries, etc. Such cutting to date essentially relies on the knowledge and skills of the human operator.

In another field of processing carcasses of slaughtered animals in abattoirs and boning plants cutting of carcasses or carcass parts is performed to create the required meat cuts such as split carcass halves as well as smaller cuts. These processes are predominantly performed manually or under manual control.

In the processing of slaughtered animals (including bovine and ovine animals, and pigs), the slaughtered animal, after removal of the bead and evisceration, is split along the spine into two halves. Automatic apparatus for carcass splitting has been proposed and developed in the past and various means have been developed for locating and tracking a saw along the spine. It is undesirable for the saw to deviate significantly from the centre of the spine since this can lead to damage to the meat and either loss of meat or reduction in value of the meat. For example, if the saw runs off the spine and cuts through meat at one side of the spine, the loss of and damage to the meat by the saw can be costly to the producer.

There have been in the past mechanical systems developed for trying to keep the carcass splitting saw accurately centred on the spine during the carcass splitting operation. For example, rigidly clamping the carcass in a known position has been proposed or attempted, but this relies on significant uniformity amongst the carcasses being processed and it has been realised that there are significant anatomical variations between individual animals. For example, a lateral deviation of the spine from the median plane of the carcass even if securely clamped against movement can cause deviation of the line of splitting from the centre of the spine.

Also in the past, attempts lave been made to mechanically track the line of the spine during the carcass splitting operation so that the saw will more accurately follow the line of the spine. For example, in patent specification U.S. Pat. No. 5,392,292 (Rankin, et al) there is disclosed a carcass splitting apparatus having a spine tracking or following means comprising rolling contact wheels whir are urged into engagement with the carcass on opposite sides of the spine and which, by straddling he spine, enable the adjacent cutting saw to remain substantially centred on the spine. In general concept, patent specification U.S. Pat. No. 4,667,368 (Menqi) discloses also a mechanical guiding device which follows the spine during the carcass splitting operation. These mechanical spine tracking or following devices rely on the spine being sufficiently well defined to be able to maintain the accurate-tracking function. If the spine is not well defined (e.g. depending on anatomical characteristics of the animal species or breed or of the individual animal carcass being split), such mechanical tracking systems can still result in inaccurate splitting of the carcass.

It is an object of the present invention in a first aspect to provide a method of automatically cutting a product having internal structures along, a path dependent on the conformation of the internal structures.

It is an object of the present invention in a second aspect to provide a method and apparatus for automatically cutting a human or animal body part along a path that is dependent on the internal tissue structures.

It is an object of the present invention in a third aspect to provide a method and apparatus for splitting the carcass of a slaughtered animal so that splitting can be accurately maintained along the centre of the spine.

It is a preferred object of the present invention in the third aspect to provide a method and apparatus for splitting the carcass of a slaughtered animal which can at least provide a useful alternative to mechanical systems for maintaining the accuracy of the carcass splitting operation.

According to the present invention in its first aspect there is provided a method from automatically cutting a product having internal structures in a manner dependent on the conformation of the internal structures, the method including the steps of supporting the product so that it is restrained against movement in at least one direction, cutting the product while supported and restrained against movement by relatively moving a cutting means so as to cut the product along a path, scanning the product ahead of the cutting location to generate data signals including data pertaining to the location and/or conformation of the internal structures of the product, processing the data signals from the scanning operation so as to generate control signals dependent on the location and/or conformation of the internal structures, and, in response to the control signals, controlling the position of the cutting means during cutting operation in at least two degrees of freedom so as to cut the product along a path dependent on conformation of the internal structures. By scanning the product to detect internal structures, it becomes possible to cut along a path to take account of those internal structures. This can be useful for a wide variety of applications such as cutting natural products such as plant matter (fruit, vegetables, timber, etc.) and animal matter (for medical/surgical or veterinary purposes or procedures, including forensic procedures) and also for cutting manufactured products, artefacts and perhaps archaeological articles.

When the product is not a rigid product and there is some degree of flexibility of the product or internal structures thereof, the step of restraining the product against movement preferably includes restraining the product in the general region where the cutting is taking place so that there is no substantial movement of the internal structures of the product after it has been scanned and the conformation of the internal structures determined but before the cutting means performs the cut along the path.

Preferably the step of scanning the product to locate the internal structures thereof occurs close to the cutting location, e.g. a few centimeters ahead of the cutting means.

The step of scanning the product preferably comprises generation of signals within the product whose echoes from reflections at interfaces between adjacent internal structures having differing densities are detected to generate the data signals. The step of scanning the product may be carried out using non-contact means such as microwave or radar scanning means to minimise wearing of the scanning components and extend the longevity thereof.

The step of scanning preferably comprises an ultrasonic scanning process in which ultrasonic pulses are generated within the product by a source that is progressively advanced along the surface of the product and in which an associated detector is provided and located to detect reflected or echo signals from interfaces between internal structures having differing densities, the detector being operative to generate the data signals.

The degrees of freedom preferably include at least one degree of freedom of rotational movement of the cutting means.

According to a second aspect of the present invention ere is provided a method for automatically cutting tissues of an animal body part which includes the steps of supporting the animal body part in such a manner that it is restrained against substantial movement in at least one direction, cutting the body part while supported by moving, a cutting means relatively along the body part, scanning the tissues of the body part ahead of the cutting location to generate data signals including data pertaining to the location and/or conformation of internal structures of the body part, processing the data signals from the scanning operation so as to generate control signals dependent on the location and/or conformation of the internal structures and, in response to the control signals controlling the position of the cutting means during the cutting operation in at least two degrees of freedom so as to cut the body part along a path dependent on the conformation of the internal structures.

When there is some degree of flexibility of the body part or internal structures thereof, the step of restraining, the body part against movement preferably includes restraining the body part in the general region where the cutting is talking place so that there is no substantial movement of the internal structures of the body part after it has been scanned and the conformation of the internal structures determined but before the cutting means performs the cut along the path.

The step of scanning the body part to locate the internal structures thereof preferably occurs close to the cutting location, e.g. a few centimeters in advance of the cutting means.

The step of scanning, the body part may comprise generation of signals within the body part whose echoes frown reflection at interfaces between adjacent internal tissue structures having differing densities are detected to generate the data signals.

In particular, the step of scanning preferably comprises an ultrasonic scanning process in which ultrasonic pulses are generated within the body part by a source that is progressively advanced along the surface of the body part and in which an associated detector is provided and located to detect reflected or echo signals from interfaces between internal tissue structures having differing densities, the detector being operative to generate the data signals.

As with the first aspect of the invention, the decrees of movement preferably include at least one degree of freedom of rotational movement of the cutting means.

The body pant may consist of a part of the carcass of a slaughtered animal and, in this case, the cutting of the part of the carcass mal separate the part into at least two carcass sub-parts with the path of the cut being dependent on conformation of bones within the carcass body part.

For example, the carcass part may comprise one of the two sides of a slaughtered quadruped which has been split along the spine, the cutting of the carcass part comprising cutting the carcass side into predetermined marketable cuts selected from forequarter, hindquarter, primal cuts including butt, rump and loin, short loin, strip loin, rib set, chuck and blade, chuck square cut, neck, brisket, shin and shank, ribs, and other standard carcass cuts.

According to a third aspect of the present invention, which is a special case of the second aspect, there is provided a method for automatically splitting the carcass of a slaughtered animal which includes the steps of supporting the carcass so that it is restrained against substantial lateral movement or other degrees of free movement, splitting the carcass while supported by relatively moving a splitting means longitudinally along the carcass, scanning the tissues of the animal carcass ahead of the splitting location to generate data signals including data pertaining to the location and/or conformation of the spine of the carcass, processing the data signals from the scanning operation so as to generate control signals dependent on the location and/or conformation of the spine, and, in response to the control signals, controlling the position of the splitting means during the splitting operation in at least two degrees of freedom so as to split the carcass along substantially the centre of the spine.

By scanning the carcass tissues ahead of the splitting location as the splitting operation progresses and by processing the data signals from the scanning operation preferably to locate the centre of the spine, it is possible to accurately maintain the line of splitting along the centre line of the spine.

The step of supporting the carcass preferably includes at least laterally restraining the carcass in the general region where the splitting operation is taking place during the process of splitting the carcass so that there is no substantial movement of the carcass spine after it has been scanned and its centreline determined but before the splitting means splits the spine. That is the scanning and splitting operations may occur close to one another in real time. Preferably the scanning means is located close to the splitting location, e.g. a few centimeters in advance of the cutting means.

Preferably the step of scanning of the tissues comprises generation of signals whose echoes are detected from reflections at interfaces between bone and other tissues. The step of scanning may comprise an ultrasonic scanning operation in which ultrasonic pulses are generated by a source that is progressively advanced along the surface of the carcass in the vicinity of the spine and an associated detector which detects reflected or echo pulses from interfaces between bone and other tissues and which generates the data signals.

Preferably the degrees of freedom include at least one degree of freedom of rotational movement of the cutting means.

The present invention in a fourth aspect also provides apparatus for automatically cutting tissues of an animal body part, the apparatus including:

support means for supporting the animal body part so that it is restrained against substantial movement in at least one direction,

cutting means operative to cut the body part while supported by the support means, the cutting means including moving means for moving the cutting means relatively along the body pant to trace a cutting path,

scanning means for scanning the tissues of the body part ahead of the cutting location of the cutting means, the scanning means being operative to generate data signals including data pertaining to the location and/or conformation of internal structures of the body part,

processing means for processing the data signals from the scanning means and being operative to generate control signals dependent on the location and/or confirmation of the internal structures, and

control means operative in response to the control signals to control the position of the cutting means during the cutting operation in at least two degrees of freedom so as to cut the body part along the cutting path dependent on the conformation of the internal structures.

The scanning means preferably comprises an ultrasonic scanner operative to generate ultrasonic pulses within the body part, the ultrasonic scanner including a source arranged to be progressively advanced along to the surface of the body parts and an associated detector which is provided and located to detect reflected or echo signals from interfaces between internal tissue structures having differing densities, the detector being operative to venerate the data signals. The detector of the scanning means is preferably operative to detect echoes of ultrasonic signals reflected at interfaces between bone and other tissues, the processing means being operative to determine from the data signals information about locations and conformations of bone within the body part.

In a particular preferred embodiment, the body part comprises the carcass of a slaughtered animal, and the cutting means comprises splitting means operative to split the carcass into two halves by cutting alone the centre line of the spine, the processing means being operative to analyse the data signals from the detector to locate the centre of the spine and to provide feedback control signals for controlling automatically the position of the splitting means as it follows the scanner alone the line of the spine. In this embodiment, the moving means preferably includes advancing drive means for advancing the splitting means long the general longitudinal line of the spine, the control means including positioning means operative in response to the control signals, the positioning means comprising at least two of:

lateral positioning means operative in response to the control signals to selectively move the splitting means laterally relative to the longitudinal line of the spine of a carcass as the splitting means is advanced by the advancing drive means,

roll positioning means operative in response to the control signals to vary the inclination of the plane of the instantaneous direction of splitting to the longitudinal line of the spine, and

tilt positioning means operative in response to the control signals to tilt the splitting means about an axis orthogonal to the plane of advancing movement of the splitting means along the spine of the carcass.

The cutting means may be moveable along lee cutting path at a variable speed, and the processing means may generate speed control signals for controlling the speed of advance of the cutting means depending upon the type and/or density and/or dimensions of the tissues being cut.

Possible and preferred features of the third and fourth aspects of the present invention will now be described with particular reference to the accompanying drawings. However it is to be understood that the features illustrated in and described with reference to the drawings are not to be construed as limiting on the scope of the invention. In the drawings:

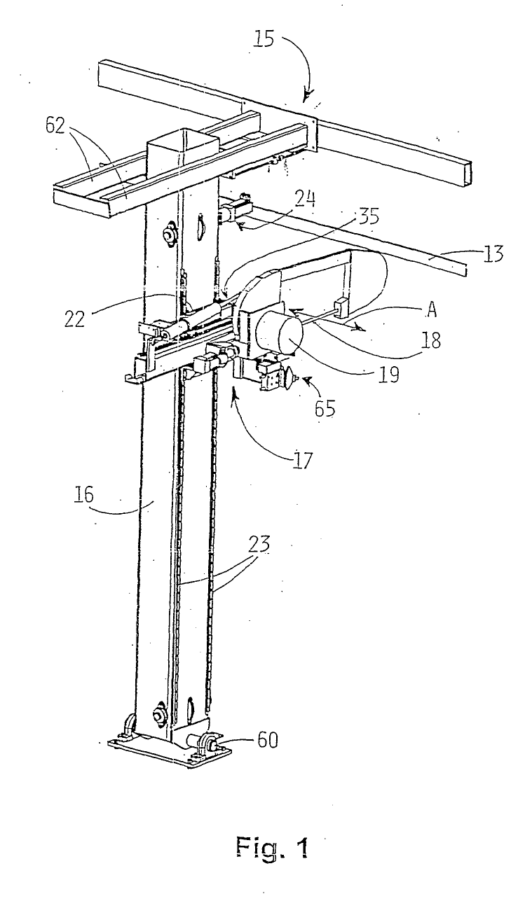

FIG. 1 is a perspective view of a carcass splitting apparatus embodying the third and fourth aspects of the present invention,

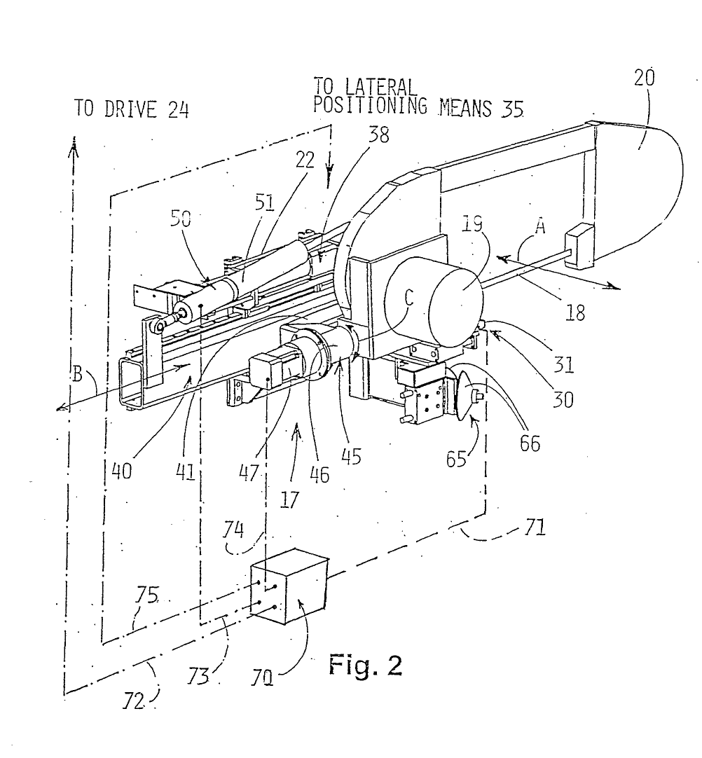

FIG. 2 is a perspective view of the splitting means used in the apparatus of FIG. 1,

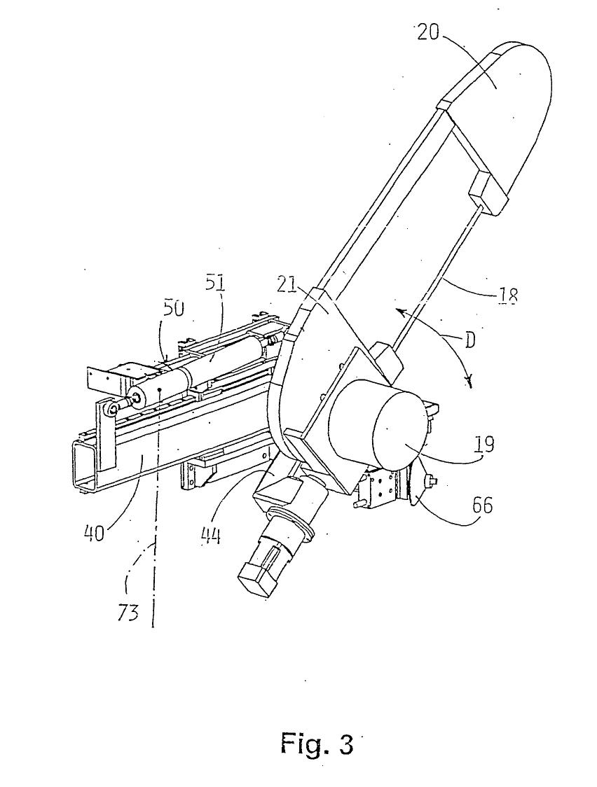

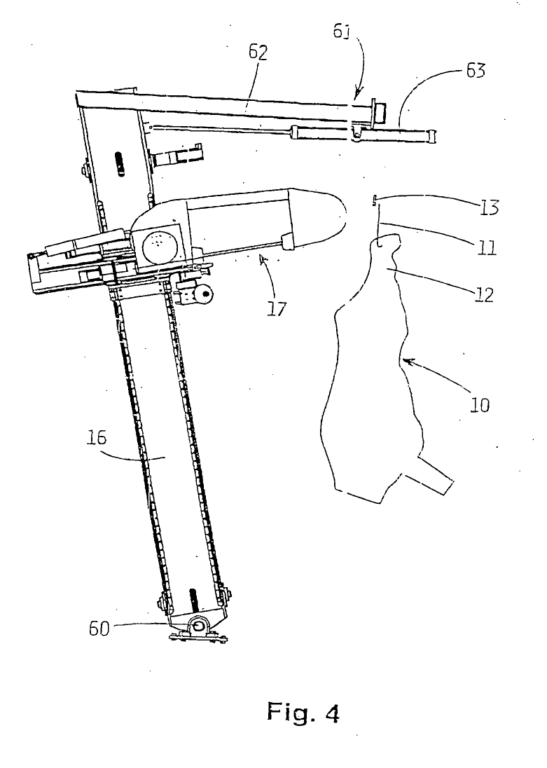

FIG. 3 is a view of the splitting means similar to FIG. 4 showing a tilting means operated,

FIG. 4 is a side elevation of the apparatus at the splitting station prior to use,

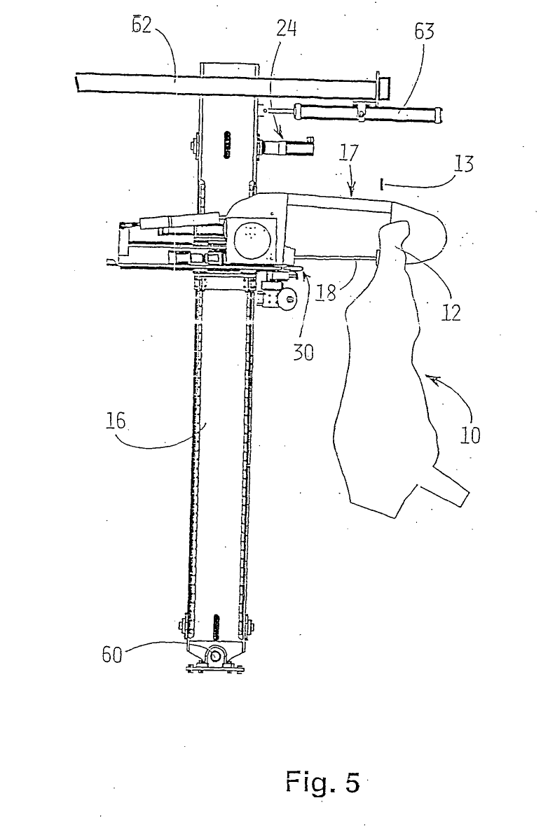

FIG. 5 is a side view showing leaning means operated to advance the splitting means towards an operative position,

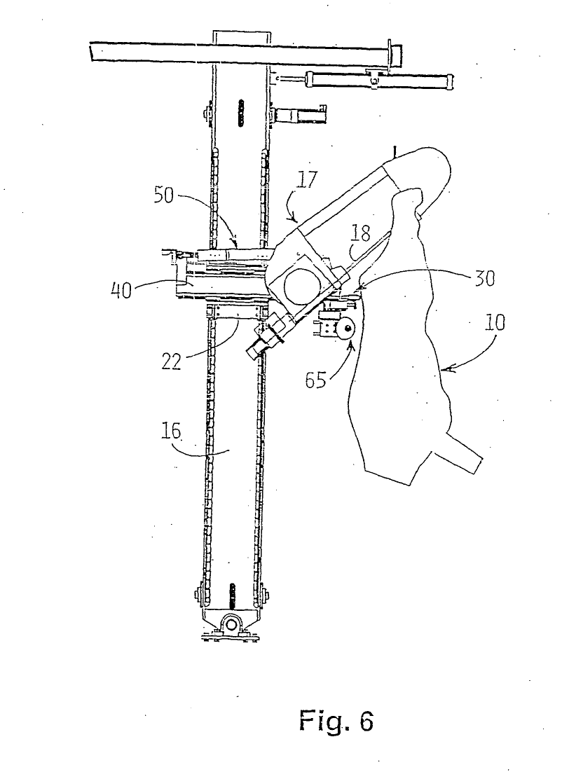

FIG. 6 is a side view of the apparatus showing, the splitting means tilted and advancing positioning, means operated to advance the splitting means and scanning means to positions ready for commencement of the splitting operation,

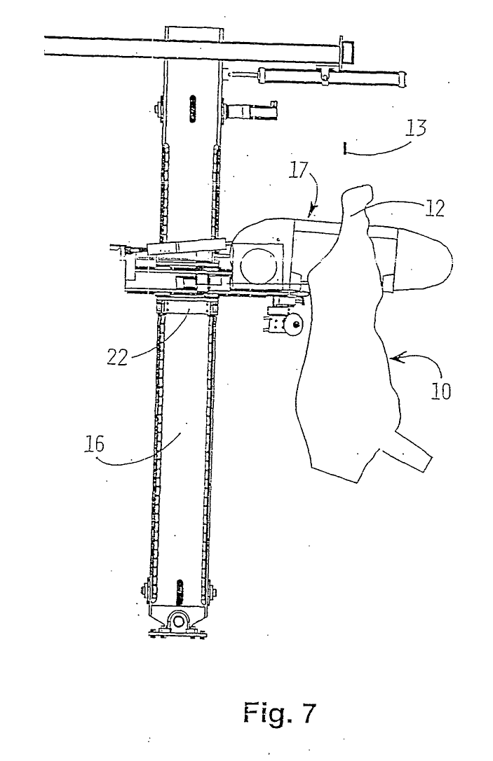

FIG. 7 shows a position of the splitting means at an early stage of the splitting operation,

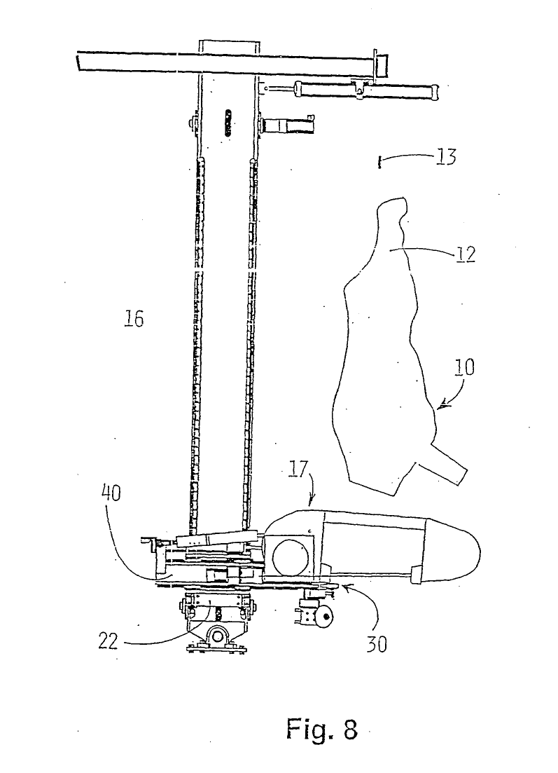

FIG. 8 shows the splitting means after having split the carcass and reached the end of its vertical travel, and

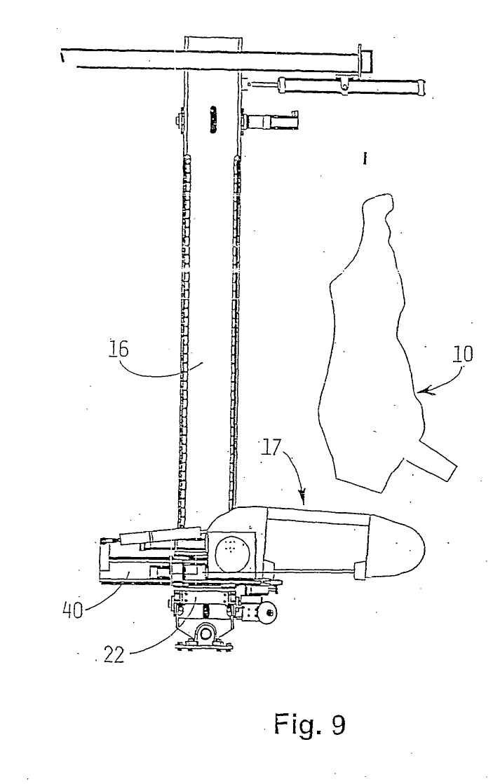

FIG. 9 shows the splitting means after having been retracted.

Referring to FIG. 4 of the drawings there is illustrated a beef carcass 10 suspended on hooks 11 (one in each hind leg 12) from an overhead rail 11. This is a conventional way of suspending a carcass in a meat processing plant. The carcass 10 has had the head, tail and hide removed, the carcass has been eviscerated, and the sternum or brisket has been split preparatory to the carcass splitting operation.

At a splitting station on the carcass processing line, there is provided a splitting apparatus 15. The apparatus 15 includes a main support 16 which extends generally upright and which supports a carcass splitter assembly 17 during its splitting operation. The assembly 17 includes a saw blade 18 which in the illustrated embodiment comprises a band saw although the invention is also applicable to other splitting mechanisms including reciprocating saws, circular saws, and also cleavers (frequently used for splitting pig carcasses). In the illustrated embodiment, the saw blade 18 has an associated drive 19 near the support 16 and the blade 18 runs around inside an inner shroud 21 and an outer shroud 20 spaced outwardly from the support 16.

The splitter assembly 17 is mounted on a carriage 22 which is selectively movable vertically along, the support 16 e.g. along tracks 23. For this purpose a vertical motion drive 24 can be provided associated with the carriage 22 for driving the carcass splitter assembly 17 generally vertically on the support 16. During a carcass splitting operation, as fully described later, the drive 24 will move the carriage 22 and saw 18 from a raised position in a downwards direction so as to split the carcass starting at the tail and moving in the cranial direction downwardly.

Also associated with the carriage 22 there may be a carcass support 65 which bears against the carcass, e.g. so as to bear some weight of the carcass. The carcass support 65 may comprise spaced rollers 66 or guides which bear against the dorsal surface of a carcass and straddle the spine and being positioned so that the rollers bear some weight of the carcass by pressing in a direction away from the support 16, whereby a positive and secure centring location of the carcass is achieved or at least assisted by the rollers 66. The saw blade 18 can cut through the spine by following in close proximity to the rollers 66 so that the spine is positively restrained against lateral movement in the region where the saw blade 18 is cutting the spines. Such an arrangement of guide rollers is further described in U.S. Pat. No. 5,312,292.

Mounted and positioned so as to move alone the spine of the carcass in advance of the cutting blade 18 is a scanner 30. In a preferred embodiment the scanner 30 is an ultrasonic device which contacts the dorsal surface of the carcass 10 a short distance in advance of the saw blade 18. An ultrasonic transducer 31 generates ultrasonic pulses at the carcass surface which propagate through the tissues. Echoes or reflections of the ultrasonic pulses arise at density, discontinuities within the carcass tissues. Because of the pronounced density discontinuity that occurs at the interface between bone tissue of the spinuous process of the spine and adjacent other tissues, such as connective tissue, muscle tissue, or fat tissue, there is strong signal reflection at the surfaces of the spine. The transducer 31 detects and generates data signals on line 71 in response to the reflected pulses and by providing processing means 70 operative to analyse these reflected pulses it is possible to determine characteristics of the spine e.g. of the location and conformation. For example, it is possible to determine the centre line of the spine alone, which it is intended the saw blade 18 will cut. It is not necessary to provide a configuration of ultrasonic transmitters and ultrasonic detectors in the transducer 31 and associated processing circuitry or software of processing means 70 to be able to accurately determine the complete profile of the spine—it is merely preferred to determine the centre line. Therefore, it may be sufficient to have a single pulse transmitter travelling substantially along the spine ahead of the saw blade 18 and a detector or two detectors adjacent or on opposite sides of the spline. The symmetry of detected reflected pulses may be sufficient for suitable analysing means 70 to determine the centre line without it being necessary to attempt to determine a detailed conformation of the spine.

The analysis of ultrasonic pulse reflections from animal tissues is a well developed technology and is used for example in determining back fat depths in animals for grading purposes. Therefore, the types of ultrasonic transducers, their configuration, the circuitry and software to analyse the detected signals can all be determined by a person skilled in the art of use of ultrasonic transducers. Alternatively, suitable configurations of transducers and processing circuitry or software can be empirically determined.

It is desirable to achieve good acoustic coupling between the transducer 31 and the dorsal surface of the carcass 10. Since it may not be acceptable to apply some known acoustic coupling materials such as some oils to meat products for human consumption in the present invention it may be preferred to spray sterile water onto the carcass 10 in the vicinity of the transducer 31 to achieve good acoustic coupling. The splitting assembly 17 may include a water spray device located to s-tray the surface of the carcass near or just ahead of he transducer 31.

By operation of the processing means 70 in analysing the detected data signals on line 70 from the transducer 31, and determining the centre line of the spine, it is possible to then generate control signals on lines 72, 73, 74, 75 to control the position of the saw blade 18 which is moving relative to the carcass a short distance behind the transducer 31.

For example, if the centre line of the spine is determined to be shifting laterally (i.e. in a direction orthogonal to the upright plane in icy he sa blade 18 is travelling and which is assumed to be the median plane of the carcass) from here the saw blade is presently located, the control signals generated on line 75 can be used to move the lateral position of the saw blade 18 to maintain it centred as it moves along the spine. For this purpose the apparatus includes a lateral positioning means 35 (obscured behind the inner shroud 21 and carriage 22) operative to selectively move the saw assembly 18, 19, 20 laterally relative to the carcass 10. As best seen in FIGS. 2 and 3, the splitter assembly, which is mounted on carriage 22, includes a base frame 40 and a sub-frame 41. The base frame 40 is mounted by the carriage 22 so as to be capable of advancing and retracting movement (in the direction of arrow B in FIG. 2) as further described later. The sub-frame 41, to which the saw assembly 18, 19, 20 is mounted, is, in turn, movably mounted to the base frame 40 by the lateral positioning means 35. The lateral positioning means 35 is operative to selectively move the sub-frame 41 linearly towards and away from the base frame 40, i.e. in the direction of arrows A, orthogonal to the vertical plane in which the saw blade 18 travels. With this arrangement, the lateral positioning means 35 can respond to control signals to position the saw blade 18 to follow the centre line of the spine even if the spine centre line deviates laterally along its length. It may be found that lateral movement of a maximum of several centimetres may be sufficient for practical operations in splitting of animal carcasses. The lateral positioning means 35 may comprise any convenient means such as for example a pneumatic or hydraulic rant mounted by the base frame 40 and coupled to the sub-frame 41 for moving the sub-frame 41 towards and away from the base frame 40.

As mentioned earlier the base frame 40 is capable of advancing and retracting movement is the carriage 29 so as to advance and retract the saw assembly 18, 19, 20. This advancing and retracting movement may be achieved by any convenient drive means 38 operating between the base frame 40 and the carriage 22. The advancing and retracting movement is not primarily designed as a degree of movement of the splitting means for control of the splitting operation but is intended more for positioning the splitting assemble preparatory to commencing the splitting operation and at the end of the splitting operation, as will be further described later in connection with the sequence depicted from FIG. 4 to FIG. 9 of the drawings.

A further degree of movement of the saw blade 18 that may be desirable to provide additional control of the carcass splitting operation is a roll control. By “roll” is meant the inclination of the plane of the instantaneous cutting direction to the vertical.

In FIG. 2 in particular there is illustrated schematically a roll positioning means 45 operative in response to control signals on line 74 from the means 70 processing the data signals 71 from the transducer 31. The roll positioning means 45 is operative to change the instantaneous cutting direction of the saw blade 18. The roll positioning means 45 includes a mounting bearing 46 through which the saw assembly 18, 19, 20 is mounted to the sub-frame 41 for limited rolling movement, i.e. angular movement of the saw assembly 18, 19, 20 about an axis generally collinear with the line of the saw blade 18. This direction of rolling movement is illustrated by the arrow C in FIG. 2. To achieve the selective angular moment of the saw assembly in the directions of arrow C, the apparatus includes a selectively operated rotary drive 47 to move the saw assembly 18, 19, 20 angularly in its mounting bearing 46.

The roll positioning means 45 would normally be used during a splitting operation in conjunction with operation of the lateral positioning means 35. For example, if the spine of the carcass bends laterally before straightening again to descend vertically, the data signals 71 front the scanner can be processed by means 70 to detect the deviation and generate control signals on lines 74, 75 to both the lateral positioning means 35 and the roll positioning means 45. By rolling the saw assembly to change the plane of cutting of the blade 18 and simultaneously causing the lateral positioning means 35 to laterally move the saw assembly 18, 19, 20, the line of splitting can accurately follow the line of the spine as it deviates laterally and again as it deviates again to resume a vertical line. By simultaneously rolling and laterally moving the blade, the mechanical stresses to which the blade 18 would be subjected by lateral movement alone or by rolling movement alone can be substantially reduced or eliminated, thereby reducing or eliminating breakage of the band saw 18 by following a crooked spine.

A further degree of movement of the saw blade 18 that is provided in the illustrated embodiment is a tilt control, i.e. controlling the inclination of the blade to the horizontal during a vertical splitting operation. As shown in FIG. 3 by comparison with FIG. 29 the apparatus includes a tilt positioning means 50 which is operative in response to control signals on line 73 to selectively tilt the saw blade 18 about a generally horizontal axis orthogonal to the plane of the cutting of the saw blade. i.e. to tilt the blade 18 in the direction of arrows D in FIG. 3. The tilt positioning means 50 in the illustrated apparatus includes a pneumatic or hydraulic ram 51 operable between the base frame 40 and a part of the saw assembly 18, 19, 20 displaced from the axis around which the tilting movement occurs. In FIG. 3 the tilting movement in the direction of arrows D occurs about the axis of the drive means 19. The point at which the ram 51 is coupled to the saw assembly call be a point on the inner shroud 21. The degree of movement of the saw blade 18 achieved by the tilt positioning means 50 can be useful in positioning the saw assembly for the commencement of a splitting operation and to start the splitting of the spine more safely and more reliably by using an inclined line of approach of the saw blade up to the initial point of contact with the spine at the base of the spine where the tail has been previously removed. This is illustrated in FIG. 6 and, as shown in FIG. 7, the tilt positioning means 50 can be operated to bring the saw back to a horizontal position when the splitting of the spine has proceeded beyond the lumbar region.

As mentioned earlier, the carriage 22 is selectively movable alone the upright main support 16 so as to carry out the splitting operation. Any convenient drive means 24 can be used to provide the vertical degree of movement of the saw blade. The vertical movement can be controlled by a predetermined program so as to achieve a predetermined throughput of carcasses.

The speed of vertical movement of the saw blade 18 controlled by the associated drive 24 can also be responsive at least in part to the means 70 processing the data signals 71 from the transducer 31. These data signals for example may provide some data about the extent of bone tissue and/or density of bone tissue so that an optimum speed of advance of the carcass splitting can be achieved. In addition or alternatively, means sensing the resistance to the advancing splitting blade 18 can provide feedback information to control the speed of vertical movement of the splitter assembly 17. Speed control signals to the drive 24 are generated on line 72 (FIG. 2).

A further possible degree of movement of the saw blade 18, although not one which is provided in the illustrated embodiment, is yaw control. It is possible to provide in the apparatus a yaw positioning means to selectively vary the angle of the blade by selective angular movement thereof about a vertical line. Then seen in plan view, the saw blade 18 can be angularly moved by an appropriate yaw positioning means to maintain accurate central splitting through the spine and carcass, particularly if there is some twisting of the spine along its length.

FIGS. 4 to 9 illustrate in side view a sequence of positions of the apparatus during a carcass splitting operation. It will be possible to better understand the method and apparatus of the present invention by reference to these drawings and the following description.

In FIG. 4, the apparatus is shown in a preliminary or standby position awaiting arrival of a carcass 10 suspended in conventional manner by its hind legs 12 from rail 13. When the carcass arrives at the splitting station in wrong of the apparatus, the splitter assembly 17 will be positioned between the spaced hind legs 12.

As shown in FIG. 4, the main support 16 is in a leant back position. This is achieved by providing a pivotal mounting 60 of the support 16 at floor level. A lean positioning means 61 is provided at the upper end of the support 16 and comprises spaced guide members 62 between which the top end of the support 16 moves. A pneumatic or hydraulic ram (or other suitable drive) 63 is selectively operated to draw the support 16 from its leant back position shown in FIG. 4 to its upright “leant forward” position shown in FIG. 5 when the carcass 10 has arrived and is located in its desired position at the splitting station. As shown in FIG. 5 the assembly 17 is then positioned between the hind legs 12 of the carcass 10 but is still in a retracted position.

As shown in FIG. 6, compared to FIG. 5, the tilt positioning means 50 can be operated to tilt the saw assembly upwardly to its inclined position shown in FIG. 6. At the same time, or subsequently, the advancing positioning means 38 is operated to advance the base frame 40 within the carriage 22 whereby the scanning means 30 is brought into operative association with the carcass 10, the scanning means 30 being positioned a short distance below the base of the spine where the tail has been removed and where the splitting operation will commence. During advancing movement of the saw assembly into the position shown in FIG. 6, the carcass lateral restraint rollers 66 or the other means to restrain the carcass against free lateral or other movements can also be advanced to adopt their operative positions engaging the carcass and straddling the spine (although for convenience in FIGS. 6 and 7 the rollers 66 are shown still retracted). The saw assembly is then operated and is moved downwardly by movement of the carriage 22 along the support 16 so that the saw blade 18 commences the splitting operation at the base of the spine and progressively advances downwardly following the line of the spine of the carcass as shown in FIG. 7. During this operation, the tilt positioning means 50 can be operated to bring the saw 18 back to a generally horizontal position.

During the splitting operation, the scanning means 30 follows the spine of the carcass, and the data signals on line 71 from the scanning means 30 are processed in processing means 70 to locate the spine and/or determine its conformation immediately ahead of the point where the saw 18 is splitting the carcass. The control signals on lines 72, 73, 74, 75 from the processing means 70 ale used to control the decrees of movement of the saw blade including (in the preferred embodiment) lateral movement (the direction of arrows A), rolling movement (the direction of arrows C), vertical movement and, if desired, tilting movement (the direction of arrows D).

When the saw assembly passes beyond the carcass and reaches the end of its vertical travel shown in FIG. 8 completing the splitting operation, the advance positioning means 38 can be operated to retract the saw assembly back towards the support 16 as shown in FIG. 9. The carcass halves now being separated and being suspended from their respective hooks can be advanced away from the splitting station suspended from the overhead rail 13 and past the saw assembly. He saw assembly in the position shown in FIG. 9 can be washed and sterilised by hot water as known in the industry. After this, the splitting assembly can be raised back up the support 16 and the support 16 can be leant back so the apparatus is returned to the position shown in FIG. 4 preparatory to arrival of the next carcass.

It will be seen that the process and apparatus for splitting carcasses of slaughtered animals according to the invention particularly as described herein in relation to the drawings, call enable accurate splitting of the carcasses along the centre line of the spine despite significant variations in characteristics and structure of successive carcasses. Not only individual differences between particular animal carcasses, but also between different ages and breeds of animals can be accommodated. Of course, gross difference, such as differences between animal species may require different processing circuitry or software for determining the respective centre lines of the spines but the principles of the process and apparatus of the present invention nevertheless remain the same.

It will also be seen that the process and apparatus for splitting carcasses of slaughtered animals according to the invention as described herein in relation to the drawings can be modified and adapted to enable automatic cutting of a human or animal body part along, a path that is dependent on the internal tissue structures. In fact the method and apparatus can be further generalised in its uses to automatically cut products having an internal structure to be considered in determining the paths of the cuts, such products including natural products such as plant matter (fruit, vegetables, timber, etc.) and animal matter (for medical/surgical or veterinary purposes or procedures, including forensic procedures) and also for cutting manufactured products, artefacts, archaeological articles.

When used in this specification and claims, the terms “comprises” and “comprising” and variations thereof mean that the specified features, steps or integers are included. The terms are not to be interpreted to exclude the presence of other features, steps or components.

1. A method for automatically cutting a product having internal structures in a manner dependent on the conformation of the internal structures, the method including the steps of supporting the product so that it is restrained against movement in at least one direction, cutting the product while supported and restrained against movement by relatively moving a cutting means so as to cut the product along a path, scanning the product ahead of the cutting location to generate data signals including data pertaining to the location and/or conformation of the internal structures of the product, processing the data signals from the scanning operation so as to generate control signals dependent on the location and/or conformation of the internal structures, and, in response to the control signals, controlling the position of the cutting means during cutting operation in at least two degrees of freedom so as to cut the product along a path dependent on conformation of the internal structures.

2. A method as claimed in claim 1 wherein the product is not a rigid product and there is some degree of flexibility of the product or internal structures thereof, the step of restraining the product against movement including restraining the product in the general region where the cutting is taking place so that there is no substantial movement of the internal structures of the product after it has been scanned and the conformation of the internal structures determined but before the cutting means performs the cut alone the path.

3. A method as claimed in claim 1 or 2 wherein the step of scanning the product to locate the internal structures thereof occurs close to the cutting location.

4. A method as claimed in any one of the preceding claims wherein the step of scanning the product comprises generation of signals within the product whose echoes from reflections at interfaces between adjacent internal structures having during densities are detected to generate the data signals.

5. A method as claimed in claim 4 wherein the step of scanning comprises an ultrasonic scanning process in which ultrasonic pulses are generated within the product by a source that is progressively advanced along the surface of the product and in which an associated detector is provided and located to detect reflected or echo signals from interfaces between internal structures having differing densities, the detector being operative to generate the data signals.

6. A method as claimed in any one of the preceding claims wherein the degrees of freedom include at least one degree of freedom of rotational movement of the cutting means.

7. A method for automatically cutting tissues of an animal body part which includes the steps of supporting the animal body part in such a manner that it is restrained against substantial movement in at least one direction, cutting the body part while supported by moving a cutting means relatively along the body part, scanning the tissues of the body part ahead of the cutting location to generate data signals including data pertaining to the location and/or conformation of internal structures of the body part, processing the data signals from the scanning operation so as to generate control signals dependent on the location and/or conformation of the internal structures and, in response to the control signals, controlling the position of the cutting means during the cutting operation in at least two degrees of freedom so as to cut the body part along a path dependent on the conformation of the internal structures.

8. A method as claimed in claim 7 wherein there is some degree of flexibility of the body part or internal structures thereof, the step of restraining the body part against movement including restraining the body part in the general region where the cutting is taking place so that there is no substantial movement of the internal structures of the body part after it has been scanned and the conformation of the internal structures determined but before the cutting means performs the cult along the path.

9. A method as claimed in claim 7 or 8 wherein the step of scanning the body part to locate the internal structures thereof occurs close to the cutting location.

10. A method as claimed in any one of claims 7 to 9 wherein the step of scanning the body part comprises generation of signals within the body part whose echoes from reflections at interfaces between adjacent internal tissue structures having differing densities are detected to generate the data signals.

11. A method as claimed in claim 10 wherein the step of scanning comprises an ultrasonic scanning process in which ultrasonic pulses are generated within the body part by a source that is progressively advanced along the surface of the body part and in which an associated detector is provided and located to detect reflected or echo signals from interfaces between internal tissue structures having differing densities, the detector beings operative to generate the data signals.

12. A method as claimed in any one of claims 7 to 11 wherein the degrees of freedom include at least one degree of freedom of rotational movement of the cutting means.

13. A method as claimed in any one of claims 7 to 12 wherein the body part consists of a part of the carcass of a slaughtered animal and wherein the cutting of the part of the carcass separates the part into at least two carcass sub-parts with the path of the cut being dependent on conformation of bones within the carcass body part.

14. A method as claimed in claim 13 wherein the carcass part comprises one of the two sides of a slaughtered quadruped which has been split along the spine, the cutting of the carcass part comprising cutting the carcass side into predetermined marketable cuts selected from forequarter, hindquarter, primal cuts including butt, rump and loin, short loin, strip loin, rib set, chuck and blade, chuck square cut, neck, brisket, shin and shank, ribs, and other standard carcass cuts.

15. A method for automatically splitting the carcass of a slaughtered animal which includes the steps of supporting the carcass so that it is restrained against substantial lateral movement or other decrees of free movement, splitting the carcass while supported by relatively moving a splitting means longitudinally along the carcass, scanning the tissues of the animal carcass ahead of the splitting location to generate data signals including data pertaining to the location and/or conformation of the spine of the carcass, processing the data signals from the scanning operation so as to generate control signals dependent on the location and/or conformation of the spine, and, in response to the control signals, controlling the position of the splitting means during the splitting operation in at least two degrees of freedom so as to split the carcass along substantially the centre of the spine.

16. A method as claimed in claim 15 wherein the step of supporting the carcass includes at least laterally restraining of the carcass in the general region where the splitting operation is taking place during the process of splitting the carcass so that there is no substantial movement of the carcass spine after it has been scanned and its centreline determined but before the splitting means splits the spine.

17. A method as claimed in claim 15 or 16 wherein the scanning means is located close to the splitting location.

18. A method as claimed in any one of claims 15 to 17 wherein the step of scanning of the tissues comprises generation of signals whose echoes are detected from reflections at interfaces between bone and other tissues.

19. A method as claimed in claim 18 wherein the step of scanning comprises an ultrasonic scanning operation in which ultrasonic pulses are generated by a source that is progressively advanced along the surface of the carcass in the vicinity of the spine and an associated detector which detects reflected or echo pulses from interfaces between bone and other tissues and which generates the data signals.

20. A method as claimed in any one of claims 15 to 19 wherein the degrees of freedom include at least one degree of freedom of rotational movement of the cutting means.

21. Apparatus for automatically cutting tissues of an animal body part, the apparatus including:
support means for supporting the animal body part so that it is restrained against substantial movement in at least one direction,
cutting means operative to cut the body part while supported by the support means, the cutting means including moving means for moving the cutting means relatively along the body part to trace a cutting path,
scanning means for scanning the tissues of the body part ahead of the cutting location of the cutting means, the scanning means being operative to generate data signals including data pertaining to the location and/or conformation of internal structures of the body part,
processing means for processing the data signals from the scanning means and being operative to generate control signals dependent on the location and/or confirmation of the internal structures, and
control means operative in response to the control signals to control the position of the cutting means during the cutting operation in at least two degrees of freedom so as to cut the body part along the cutting path dependent on the conformation of the internal structures.

22. Apparatus as claimed in claim 18 wherein the scanning means comprises an ultrasonic scanner operative to generate ultrasonic pulses within the body part, the ultrasonic scanner including a source arranged to be progressively advanced along the surface of the body part and an associated detector which is provided and located to detect reflected or echo signals from interfaces between internal tissue structures having differing densities, the detector being operative to generate the data signals.

23. Apparatus as claimed in claim 22 wherein the detector of the scanning means is operative to detect echoes of ultrasonic signals reflected at interfaces between bone and other tissues, the processing means being operative to determine from the data signals information about locations and conformations of bone within the body part.

24. Apparatus as claimed in any one of claims 21 to 23 wherein the body part comprises the carcass of a slaughtered animal, and the cutting means comprises splitting means operative to split the carcass into two halves by cutting along the centre line of the spine, the processing means being operative to analyse the data signals from the detector to locate the centre of the spine and to provide feedback control signals for controlling automatically the position of the splitting means as it follows the scanner along the line of the spine.

25. Apparatus as claimed in claim 24, the moving means including advancing drive means for advancing the splitting means along the general longitudinal line of the spine, the control means including positioning means operative in response to the control signals, the positioning means comprising at least two of:
lateral positioning means operative in response to the control signals to selectively move the splitting means laterally relative to the longitudinal line of the spine of a carcass as the splitting means is advanced by the advancing drive means,
roll positioning means operative in response to the control signals to vary the inclination of the plane of the instantaneous direction of splitting to the longitudinal line of the spine, and
tilt positioning means operative in response to the control signals to tilt the splitting means about an axis orthogonal to the plane of advancing movement of the splitting means along the spine of the carcass.

26. Apparatus as claimed in any one of claims 21 to 25 wherein the cutting, means is moveable along the cutting path at a variable speed, and wherein the processing means generates speed control signals for controlling the speed of advance of the cutting means depending upon the type and/or density and/or dimensions of the tissues being cut.
